(19) United States
(12) Patent Application Publication
(10) Pub. No.: US 2008/0067205 A1
(43) Pub. Date: Mar. 20, 2008

(54) Article transportation securing device

(76) Inventor: Richard J. Semendoff, Port Jefferson, NY (US)

Correspondence Address: BODNER & O'ROURKE, LLP, 425 BROADHOLLOW ROAD, SUITE 108, MELVILLE, NY, 11747, US

(21) Appl. No.: 11/901,044

(22) Filed: Sep. 14, 2007

Related U.S. Application Data
(60) Provisional application No. 60/844,530, filed on Sep. 14, 2006.

(51) Int. Cl. B60R 7/04

(52) U.S. Cl. 224/275

(57) ABSTRACT

An article securing device for carrying articles in a vehicle on a vehicle seat includes an adjustable support plate, a first lip extending outwardly from the top surface of the support plate at the front edge thereof, and an adjustable leg extending outwardly from the bottom surface of the support plate at the rear edge thereof. The article securing device further includes a strap which is positionable over the top surface of the support plate to hold articles on the support plate. The article securing device is placed on a car seat, with the leg being situated near the backrest of the car seat and the lip being situated near the front edge of the car seat so that the support plate and any articles resting thereon remain level as the articles are being transported in the vehicle on the vehicle seat.

### CROSS-REFERENCE TO RELATED APPLICATION

This application is related to U.S. Provisional Application Ser. No. 60/844,530, filed on Sep. 14, 2006, and entitled “Boxed Food Transportation Securing Device”, the disclosure of which is incorporated herein by reference and on which priority is hereby claimed.

### BACKGROUND OF THE INVENTION

1. Field of the Invention

The present invention relates to securing devices for boxed food and other types of articles, and more specifically relates to devices that are designed to secure pizza boxes during vehicular transportation.

2. Description of the Prior Art

Conventionally, it is current practice to place boxed foods and other articles on the seats of vehicles during transportation in an unsecured manner. The hazards associated with this practice are significant. The operator of the vehicle is constantly checking the status of the transported object, checking its position, orientation and condition, which leads to decreased focus on the operator's surroundings and placing an unjustifiable risk on the public. Short stops, impacts and accelerations can lead to the unsecured article becoming airborne projectiles capable of physical injury. The unsecured objects also can be independently damaged due to shifting, tipping or falling from the vehicle seat. Specifically, pizza contained in a conventional pizza box may be damaged or so shifted as to become unappealing to consume, or may become dislodged from the box and fall to the vehicle floor. The unsecured portage of pizza and other foods may lead to leakage of the food contents from the box and possible damage to the transporting vehicle or injury to the occupants.

### OBJECTS AND SUMMARY OF THE INVENTION

It is an object of the present invention to provide an article securing device which secures articles being transported in a vehicle to the seat of the vehicle.

It is another object of the present invention to provide a device for securing one or more pizza boxes in a stacked arrangement to an automobile seat.

It is a further object of the present invention to provide an article securing device which is adaptable to secure articles of varying heights being transported in an automobile.

In accordance with one form of the present invention, an article securing device for securing at least one article being transported in a vehicle includes a support plate having a top surface for supporting the at least one article thereon, and a bottom surface situated opposite the top surface, a front edge and a rear edge situated opposite the front edge. The device also includes a first lip, the first lip being situated at the front edge of the support plate and extending outwardly from the top surface of the support plate. The device further includes a leg, the leg being situated at the rear edge of the support plate and extending outwardly from the bottom surface of the support plate in a direction opposite to the direction in which the first lip extends. The article securing device further preferably includes a strap which is positionable over the top surface of the support plate to hold the at least one article on the support plate.

Preferably, the article securing device is positioned on an automobile seat which has a naturally contoured surface that rises from where the seat meets the backrest. The article securing device is placed on the seat so that the leg thereof rests near where the seat joins the backrest, with the support plate extending therefrom toward the front of the seat. If desired, the waist strap of the seatbelt may wrap in front of the leg so that the leg is held between the strap and the backrest and secured thereby. Because of the naturally contoured sloping surface of the vehicle seat, the support plate resides in a generally horizontal plane when resting on the automobile seat.

An article may be placed on the top surface of the securing device, between the backrest and the upwardly extending first lip. If desired, the strap may be used and positioned over the article resting on the support plate to hold the article in place on the support plate.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of an article securing device formed in accordance with the present invention shown resting on the passenger seat of an automobile.

FIG. 2 is a partially exploded isometric view of an article securing device constructed in accordance with one form of the present invention.

FIG. 3 is an isometric view of the article securing device of the present invention shown in FIG. 2, and illustrated in an extended state.

FIG. 4 is an exploded, top isometric view of the article securing device of the present invention shown in FIGS. 2 and 3.

FIG. 5 is an exploded, bottom isometric view of the article securing device of the present invention shown in FIG. 4.

FIG. 6 is a partially exploded, top isometric view of an article securing device constructed in accordance with a second embodiment of the present invention.

FIG. 7 is a top isometric view of an article securing device constructed in accordance with a third form of the present invention.

FIG. 8 is a perspective view of the article securing device of the present invention, shown securing a stacked arrangement of pizza boxes on an automobile seat.

FIG. 9 is a side view of the article securing device shown in FIG. 8, and illustrating its preferred placement on an automobile seat and how the particular structure of the article securing device maintains the pizza boxes carried thereon in a generally horizontal disposition.

### DETAILED DESCRIPTION OF THE PREFERRED EMBODIMENTS

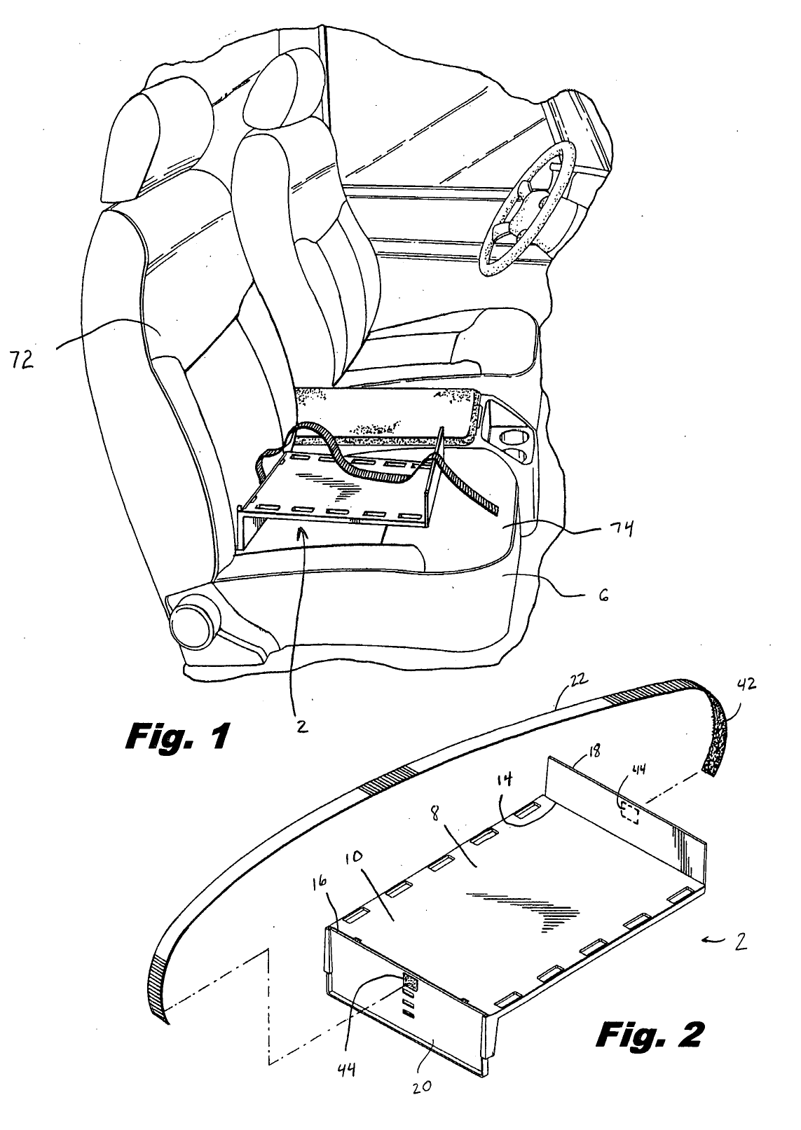

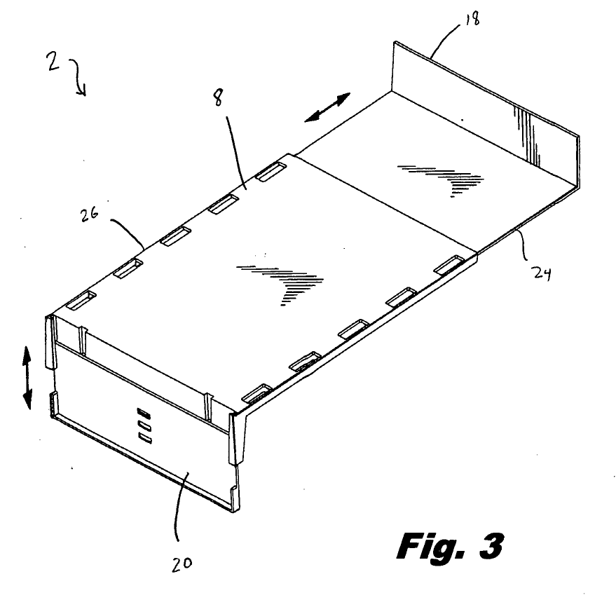

Referring initially to FIGS. 1-5 of the drawings, it will be seen that an article securing device 2 for securing articles 4, such as pizza boxes, to the seat 6 of an automobile and for maintaining the article in a substantially horizontal disposition includes a support plate 8. The support plate 8 has a top surface 10 provided for supporting at least one article 4 thereon, such as a pizza box, or a plurality of articles 4, such as a stacked arrangement of pizza boxes, packages, containers or other articles. The support plate 8 also includes a bottom surface 12 which is situated opposite the top surface 10, a front edge 14 and a rear edge 16 situated longitudinally opposite the front edge 14.

The article securing device 2 further includes a first lip 18 which is situated at the front edge 14 of the support plate 8 and extends outwardly from the top surface 10 of the support plate 8. Additionally, the article securing device 2 further includes a leg 20. The leg 20 is situated at the rear edge 16 of the support plate 8 and extends outwardly from the bottom surface 12 of the support plate 8 in a direction opposite to the direction in which the first lip 18 extends.

Furthermore, the article securing device 2 may include a strap 22 which is positionable over the top surface 10 of the support plate 8 to hold the at least one article 4 on the support plate.

More specifically, the support plate 8 is preferably formed to be dimensionally adjustable. The support plate 8 includes a planar first section 24 and a planar second section 26, the first section 24 being slidably mounted to the second section 26. The first lip 18 is situated on the first section 24, and the leg 20 is situated on the second section 26. Each of the first and second sections 24, 26 includes a top surface 28 and a bottom surface 30 situated opposite the top surface 28, and opposite lateral edges 32. The top surfaces 28 of the first and second sections 24, 26 define the top surface 10 of the support plate 8, and the bottom surfaces 30 of the first and second sections 24, 26 define the bottom surface 12 of the support plate 8.

As can be seen from FIG. 5 of the drawings, the first section 24 is slidably mounted to the second section 26 on the bottom surface 30 thereof. More specifically, the second section 26 of the support plate 8 includes a plurality of support brackets 34 that extend from each lateral edge 32 of the second section 26 partially inwardly of the second section, the support brackets 34 being spaced apart from the bottom surface 30 of the second section 26 so as to define with the bottom surface 30 of the second section a channel 36 on each lateral side 32 of the second section 26, which channels 36 slidably receive the lateral edges 30 of the first section 24 and allow the first section 24 to move longitudinally relative to the second section 26. In this way, the longitudinal length of the support plate 8 may be adjusted by the user to carry different sized articles 4 thereon.

In order to retain the first section 24 of the support plate 8 to the second section 26, a slot 38 is preferably formed through the thickness of the first section 24 and extends partially along the longitudinal length thereof. A projection 40 extends outwardly from the bottom surface 30 of the second section 26, which projection 40 is received by the slot 38 of the first section 24 and is slidable therein. The user may retract the first section 24 into the second section 26 until the projection 40 engages the first section 24 defining one axial end of the slot 38. Alternatively, the user may extend the first section 24 from the second section 26 until the projection 40 engages the first section 24 defining the opposite axial end of the slot 38. Further extension of the support plate 8 is not possible, as the projection 40 acts as a stop which abuts against the axial end of the slot 38 formed in the first section 24. Thus, the first section 24 is slidably retained by the second section 26, yet is adjustable relative thereto to provide the support plate 8 of the article securing device 2 with an adjustable dimension in the longitudinal direction.

As can be seen from FIG. 2 of the drawings, and as mentioned previously, the article securing device 2 of the present invention preferably includes a strap 22. The strap 22 is dimensioned to have a length which is sufficient to secure any articles 4, packages or stacked arrangement of articles or packages to the article securing device 2. Preferably, Velcro® hook and loop fasteners 42 are mounted to one side of the strap 22 either along the entire length thereof or along portions situated at the opposite longitudinal ends of the strap. Mating Velcro® hook and loop fastening patches 44, which interlock with the hook and loop fastening material 42 of the strap 22, are adhesively secured and positioned either on the outside surface of the leg 20, for example, the top surface 10 of the support plate 8 or the inside or outside surface of the first lip 18, with the patches 44 being preferably centered from the lateral edges 52 of the leg 20, support plate 8 or first lip 18. In this way, the user may adjust the length of the strap 22 appropriately to engage the article or articles 4 carried by the article securing device 2 of the present invention in a secure manner. Although Velcro® hook and loop fasteners 42, 44 are described and shown in the drawings, it is envisioned to be within the scope of the present invention to include other types of interlocking fasteners, such as snaps, on the strap 22 and surfaces of the leg 20, support plate 8 or first lip 18 to secure any articles 4 resting on the support plate 8 using the strap 22 adjusted appropriately in length.

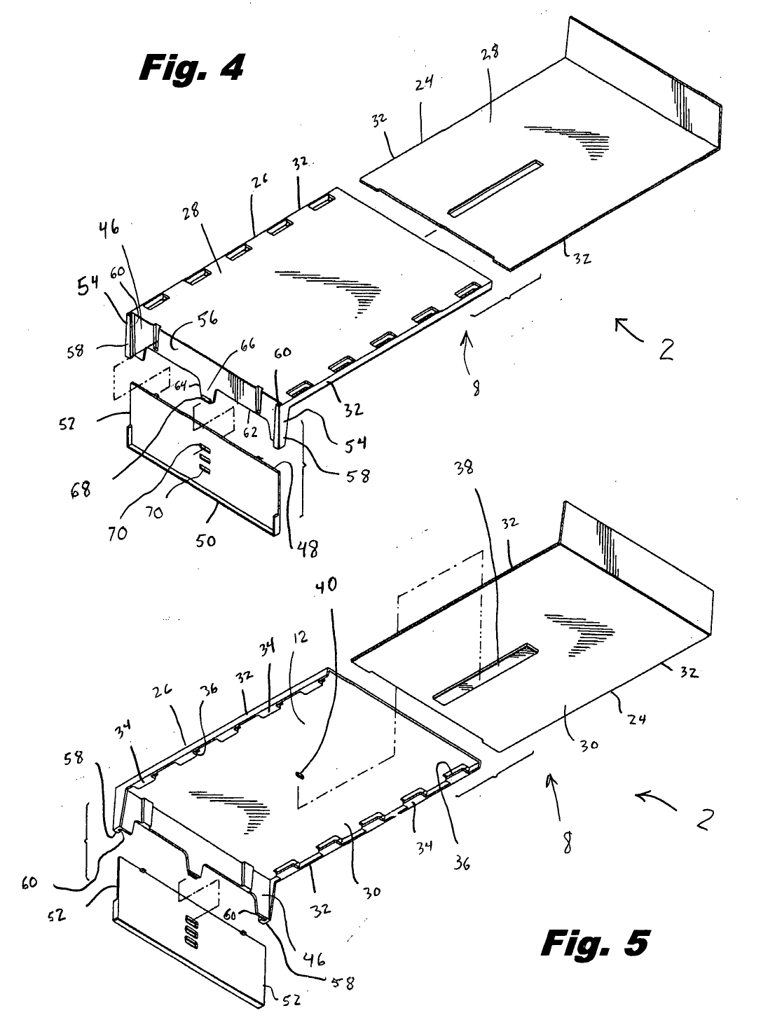

As can also be seen in FIGS. 4 and 5 of the drawings, the leg 20 is preferably a plate-like member that is adjustably mounted to the support plate 8, and in particular, the second section 26 thereof, so that the user may adjust the height of the support plate 8 relative to a supporting surface, such as the car seat 6, on which the article securing device 2 is placed. More specifically, the support plate 8, and in particular, the second section 26 thereof, includes a planar, leg supporting member 46 situated at the rear edge 16 thereof. The leg 20 is slidably mounted to the leg supporting member 46. The leg 20 also includes a top edge 48, a bottom edge 50 situated opposite the top edge 48 and opposite lateral edges 52.

Even more specifically, the leg supporting member 46 includes opposite lateral edges 54, an outer surface 56 and a pair of spaced apart, L-shaped brackets 58 extending from the outer surface 56 thereof and situated at the lateral edges 54 of the leg supporting member 46. The L-shaped brackets 58 define with the outer surface 56 of the leg supporting member 46 respective channels 60. Each channel 60 slidably receives a respective lateral edge 52 of the leg 20. Thus, the leg 20 is slidably received by the L-shaped brackets 58 of the leg supporting member 46, and is adjustable thereon by the user.

The article securing device 2 of the present invention preferably has a provision for maintaining the leg 20 in a selected position with respect to the support plate 8. More specifically, the leg supporting member 46 includes a bottom edge 62 which has a resilient finger 64 extending outwardly therefrom, which resilient finger 64 is preferably centrally located between the lateral edges 54 of the leg supporting member 46. The resilient finger 64 includes an outer surface 66, and a projection 68 extending outwardly from the outer surface 66. The leg 20 includes a plurality of spaced apart openings 70 formed at least partially through the thickness thereof and preferably situated centrally on the leg 20 in a stacked arrangement between the bottom edge 50 and the top edge 48 of the leg 20. The projection 68 of the resilient finger 64 of the leg supporting member 46 is selectively receivable in one of the plurality of spaced apart openings 70 formed in the leg 20 to allow the leg 20 to be adjustably positioned relative to the leg supporting member 46 of the support plate 8, thereby allowing the user to adjust the height of the support plate 8 relative to a supporting structure in the vehicle on which the apparatus 2 is placed, such as the vehicle seat 6.

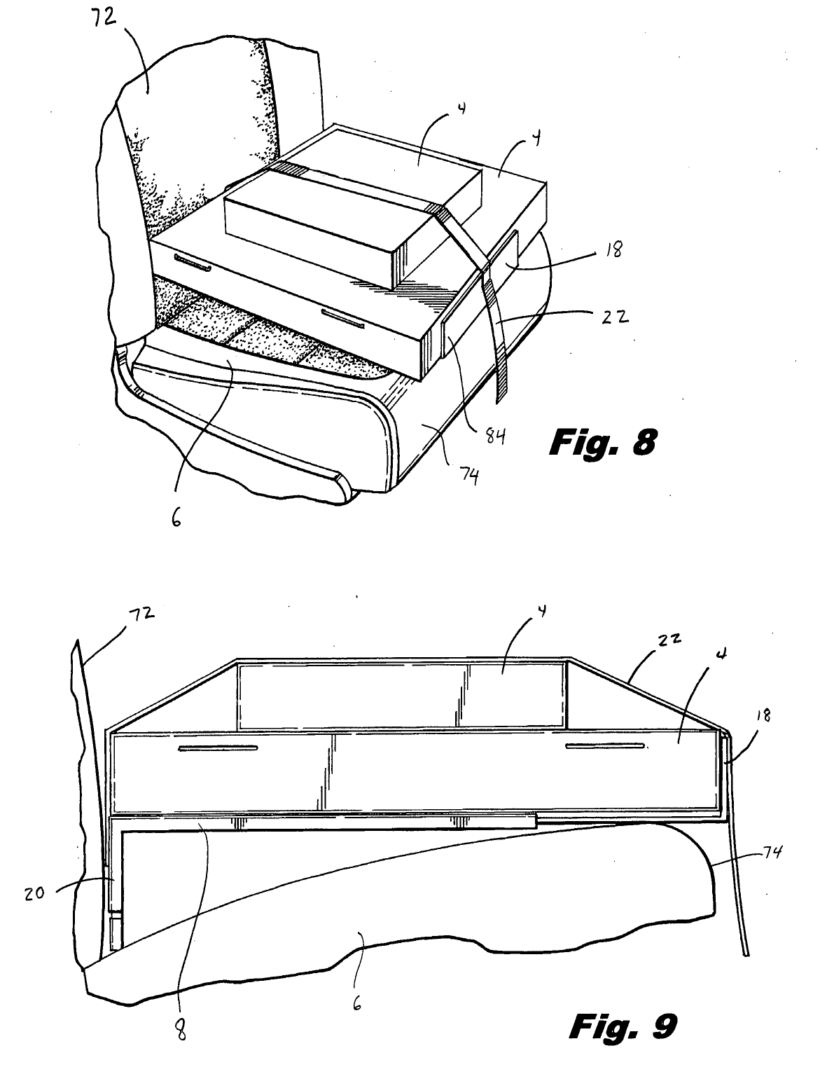

Referring now to FIGS. 8 and 9 of the drawings, it can be seen that the article securing device 2 of the present invention is preferably positioned on a vehicle seat 6, which is generally contoured and which rises from where the seat 6 meets the backrest 72 toward the front edge 74 of the seat 6. The article securing device 2 is oriented on the automobile seat 6 with the first lip 18 situated near the front edge 74 of the seat 6. The leg 20 of the article securing device 2 is positioned at the juncture between the seat 6 and the backrest 72 and, if desired, may have the waist strap of the seatbelt (not shown) wrapped about the leg 20 so that the leg 20 is between the seatbelt and the backrest 72, which secures the article securing device 2 in place on the car seat 6. Furthermore, the leg 20 may be adjusted by the user relative to the support plate 8 so that the height of the support plate 8 is generally substantially horizontal when the article securing device 2 is positioned on the car seat 6. Additionally, as can be seen in FIGS. 8 and 9 of the drawings, the user may adjust the length of the support plate 8 by extending the first section 24 from the second section 26 thereof so as to ensure that the article or articles 4 carried by the device 2 are situated between the backrest 72 of the vehicle seat 6 and the first lip 18 of the article securing device 2. The strap 22 is adjusted in length to tightly fit over the article or articles 4 supported by the article securing device 2 to further ensure that the articles do not move during their transportation in the vehicle.

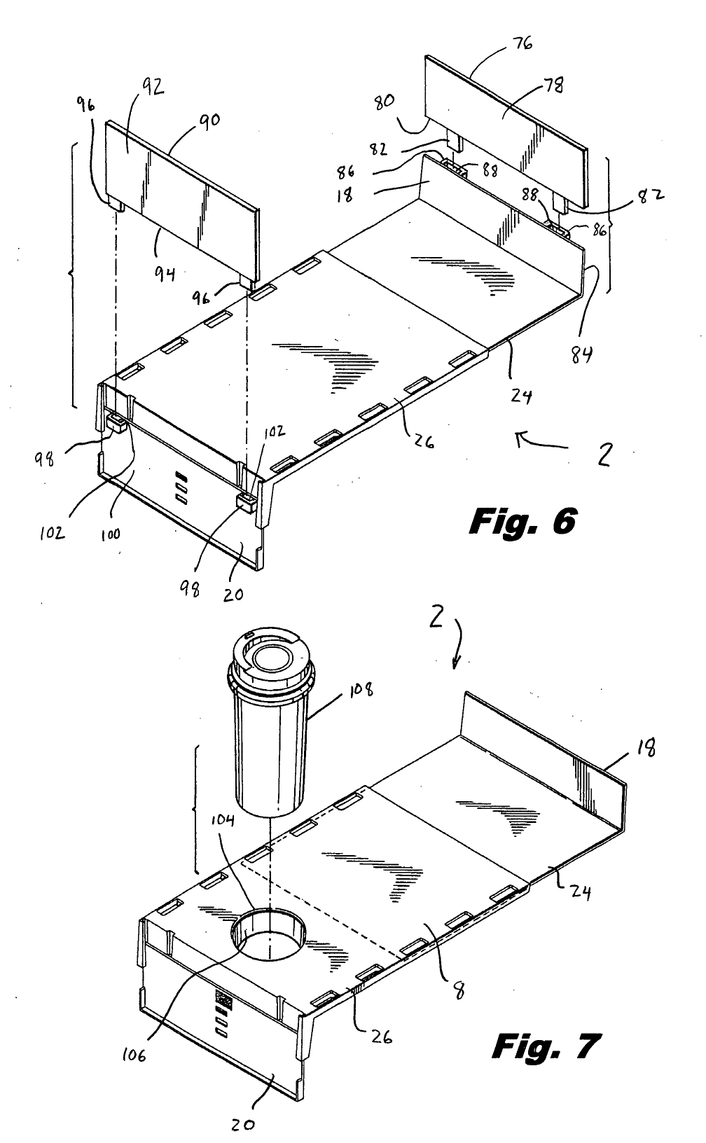

A second embodiment of the present invention is illustrated by FIG. 6. There, it will be seen that the first lip 18 may be effectively increased in height by using a lip extension member 76. The lip extension member 76 is preferably removably attached to the first lip 18. The lip extension member 76 includes a plate-like main body 78 having a bottom edge 80, and at least one tab 82, but more preferably two tabs 82, extending outwardly from the bottom edge 80 of the main body 78. The first lip 18 includes an outer surface 84 and at least one U-shaped member 86, but preferably two U-shaped members 86, extending outwardly from the outer surface 84 of the first lip 18. The U-shaped member or members 86 define with the outer surface 84 of the first lip 18 a slot 88 for removably receiving a respective tab 82 of the lip extension member 76 to allow the lip extension member 76 to be removably mounted on the first lip 18, thereby extending the overall height of the first lip 18. Thus, if a large article, or a stack of articles 4, is to be carried by the article securing device 2 of the present invention, the extension member 76 may be used to increase the overall height of the front first lip 18 to further secure the articles or stack of articles 4 in place on the article securing device 2.

Also, as can be seen from FIG. 6 and in accordance with the second embodiment of the present invention, the article securing device 2 may include a second lip 90 situated at the rear edge 16 of the support plate 8 and extending outwardly from the top surface 10 of the support plate 8. The second lip 90 is preferably removably mounted to at least one of the leg 20 and the support plate 8. The second lip 90 is similar in structure to the lip extension member 76, and preferably includes a plate-like main body 92 having a bottom edge 94, and at least one tab 96, but more preferably two tabs 96, extending outwardly from the bottom edge 94 thereof.

At least one of the leg 20 and the support plate 8 includes a surface and a slot defining member situated on the surface. At can be seen from FIG. 6 of the drawings, the slot defining member may be a U-shaped member 98, or more preferably, a pair of U-shaped members 98, which extend outwardly from the outer surface 100 of the leg 20 and which define a slot 102 for removably receiving a respective tab 96 of the second lip 90 to allow the second lip 90 to be removably mounted to at least one of the leg 20 and the support plate 8. If the second lip 90 is mounted to the support plate 8, in the removable version thereof, the support plate 8 may include one or more slots (not shown) formed through the thickness thereof, which slots removably receive the tabs 96 of the second lip 90. Alternatively, the second lip 90 need not be removably mounted to either the leg 20 or the support plate 8; rather, the second lip 90 may be permanently mounted on either the leg 20 or the support plate 8.

FIG. 7 shows a third embodiment of the article securing device 2 formed in accordance with the present invention. Here, an opening 104 may be formed through the thickness of the support plate 8, such as at the second section 26 thereof, and, if desired, a downwardly extending circular flange 106 situated on the bottom surface 12 of the support plate 8 and surrounding the opening 104 may be provided. The first section 24 of the support plate 8 may be retractable within the second section 26 up to where the opening 104 and surrounding flange 106 are located in the second section 26. Alternatively, the end of the first section 24 that is situated opposite the end where the first lip 18 is located may include an open slot (not shown), the width of such slot being greater than the diameter of the opening 104 and the flange 106 surrounding the opening 104 to allow the first section 24 to be fully retracted within the second section 26 of the support plate 8.

The opening 104 is provided to allow the user, if he so desires, to insert a beverage container 108 within the opening 104 when the article securing device 2 is not being used for carrying articles 4. The article securing device 2 will maintain the beverage container 108 in an upright position on the vehicle seat 6. The bottom of the beverage container 108 may rest against the vehicle seat 6, or a cross member (not shown) extending diametrically across the circular flange 106 and opening 104 may be provided to support the bottom of the beverage container 108.

The article securing device 2 of the present invention secures articles 4 in a safe manner as they are being transported in a vehicle. Either a single article 4 or a stacked arrangement of articles 4 may be supported by the device. Furthermore, the strap 22 may be adjusted so that articles of varying sizes may be secured by the device 2 to a vehicle seat 6.

The article securing device 2 of the present invention is adaptable by the user in many ways, including to effectively raise the height of the first lip 18 by including the lip extension member 76, to add a removable second lip 90 and to adjust the height of the leg 20 so that the support plate 8 and any box of food, such as pizza, resting thereon remain substantially level when the article securing device 2 of the present invention is placed on a vehicle seat 6.

Although the article securing device 2 of the present invention is primarily designed to be placed on a vehicle seat 6, it is envisioned to be within the scope of the present invention to use the article securing device 2 in the trunk of the automobile or other location so that the articles 4 carried thereby will not move loosely about the trunk or other location during their transportation.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. Apparatus for supporting at least one article in a vehicle, which comprises:
a support plate, the support plate having a top surface for supporting the at least one article thereon, and a bottom surface situated opposite the top surface, a front edge and a rear edge situated opposite the front edge;
a first lip, the first lip being situated at the front edge of the support plate and extending outwardly from the top surface of the support plate; and
a leg, the leg being situated at the rear edge of the support plate and extending outwardly from the bottom surface of the support plate in a direction opposite to the direction in which the first lip extends.

2. Apparatus for supporting at least one article in a vehicle as defined by claim 1, which further comprises:
a strap, the strap being positionable over the top surface of the support plate to hold the at least one article on the support plate.

3. Apparatus for supporting at least one article in a vehicle as defined by claim 2, wherein the strap includes a first fastener, and at least one of the support plate, first lip and leg includes a second fastener, the first fastener cooperatively mating with the second fastener to selectively secure the strap to the at least one of the support plate, first lip and leg.

4. Apparatus for supporting at least one article in a vehicle as defined by claim 3, wherein the first fastener and the second fastener are cooperating hook and loop fasteners.

5. Apparatus for supporting at least one article in a vehicle as defined by claim 1, wherein the support plate is dimensionally adjustable.

6. Apparatus for supporting at least one article in a vehicle as defined by claim 5, wherein the support plate includes a planar first section and a planar second section, the first section being slidably mounted to the second section, the first lip being situated on the first section, the leg being situated on the second section.

7. Apparatus for supporting at least one article in a vehicle as defined by claim 6, wherein each of the first and second sections includes a top surface and a bottom surface situated opposite the top surface, the top surfaces of the first and second sections defining the top surface of the support plate, and the bottom surfaces of the first and second sections defining the bottom surface of the support plate.

8. Apparatus for supporting at least one article in a vehicle as defined by claim 7, wherein at least one of the first section and the second section has a slot formed through the thickness thereof, and wherein the other of the first section and the second section includes a projection extending outwardly from the bottom surface thereof, the projection being received by the slot and being slidable therein along the length thereof.

9. Apparatus for supporting at least one article in a vehicle as defined by claim 1, wherein the leg is dimensionally adjustable to adjust the height of the support plate relative to a supporting surface in the vehicle on which the apparatus is placed.

10. Apparatus for supporting at least one article in a vehicle as defined by claim 9, wherein the support plate includes a leg supporting member situated at the rear edge thereof, the leg being in the form of a generally plate-like member and being slidably mounted to the leg supporting member.

11. Apparatus for supporting at least one article in a vehicle as defined by claim 10, wherein the leg includes opposite lateral edges, and wherein the leg supporting member includes a surface and a pair of spaced apart, L-shaped brackets extending from the surface thereof, the L-shaped brackets defining with the surface of the leg supporting member respective channels, each channel slidably receiving a respective lateral edge of the leg.

12. Apparatus for supporting at least one article in a vehicle as defined by claim 11, wherein the leg supporting member further includes a resilient finger, the resilient finger including an exposed surface and a projection extending outwardly from the exposed surface; and wherein the leg includes a plurality of spaced apart openings formed at least partially through the thickness thereof, the projection of the resilient finger being selectively receivable in one of the plurality of spaced apart openings to allow the leg to be adjustably positioned relative to the leg supporting member, thereby adjusting the height of the support plate relative to a supporting structure in the vehicle on which the apparatus is placed.

13. Apparatus for supporting at least one article in a vehicle as defined by claim 1, which further comprises:
a lip extension member, the lip extension member being removably attachable to the first lip.

14. Apparatus for supporting at least one article in a vehicle as defined by claim 13, wherein the lip extension member includes a plate-like main body having a bottom edge, and at least one tab extending outwardly from the bottom edge; and wherein the first lip includes an outer surface and at least one U-shaped member extending outwardly from the outer surface, the U-shaped member defining with the outer surface of the first lip a slot for removably receiving the tab of the lip extension member to allow the lip extension member to be removably mounted on the first lip.

15. Apparatus for supporting at least one article in a vehicle as defined by claim 1, which further comprises:
a second lip, the second lip being situated at the rear edge of the support plate and extending outwardly from the top surface of the support plate.

16. Apparatus for supporting at least one article in a vehicle as defined by claim 15, wherein the second lip is removably mounted to at least one of the leg and the support plate.

17. Apparatus for supporting at least one article in a vehicle as defined by claim 16, wherein the removable second lip includes a plate-like main body having a bottom edge, and at least one tab extending outwardly from the bottom edge; and wherein at least one of the leg and the support plate includes structure for defining at least one slot for removably receiving the tab of the second lip to allow the second lip to be removably mounted to at least one of the leg and the support member.
